(19) United States
(12) Patent Application Publication
(10) Pub. No.: US 2008/0022709 A1
(43) Pub. Date: Jan. 31, 2008

(54) Cooling system

(75) Inventor: James E. McKee, Grapevine, TX (US)

Correspondence Address: F. LINDSEY SCOTT;LAW OFFICE OF F. LINDSEY SCOTT, 2329 COIT ROAD, SUITE B, PLANO, TX, 75075-3796, US

(73) Assignee: Dristeel Technology, LLC.

(21) Appl. No.: 11/825,543

(22) Filed: Jul. 6, 2007

Related U.S. Application Data
(60) Provisional application No. 60/834,361, filed on Jul. 31, 2006.

(51) Int. Cl. F24F 6/02; B05B 3/18; G05B 15/00

(52) U.S. Cl. 62/314; 239/750; 700/275

(57) ABSTRACT

A system for cooling a water stream with an inlet air stream to produce a cooled water stream useable with a cooling coil to produce chilled water for a hydronic cooling system or for other purposes. The system is also effective to cool refrigerant and to supply cool water for a ground well system. The system is also effective to cool refrigerant and to supply cool water for a ground well system

### RELATED APPLICATIONS

This application is entitled to and hereby claims the benefit of the filing date of U.S. provisional application No. 60/834,361 filed Jul. 31, 2006.

### FIELD OF THE INVENTION

The present invention relates to a system for cooling a water stream with a cooled air stream to produce a cooled water stream which is useable with a cooling coil to produce chilled water for a hydronic cooling system or for other purposes.

### BACKGROUND OF THE INVENTION

In many areas of the country, there is a great need for cooling for dwellings and other buildings but relatively little need for heating. In such areas, hydronic cooling has been used extensively. Hydronic coolers, such as the CW Series of Upflow Wall/Closet Fan Coils 2—Pipe Water Cooling Systems produced and marketed by First Operations LP-P.O. Box 270969, Dallas, Tex. 75227, have been used for such purposes. Such coolers include a compression system, wherein a refrigerant, such as a halogenated hydrocarbon is compressed and cooled using cooling water to produce a cooled liquid refrigerant stream which is then vaporized in heat exchange with a water stream to produce a chilled water stream which is used for circulation to hydronically cool an area such as a dwelling. The stream of chilled water is passed through a system of conduits to a system of heat exchangers in the areas to be cooled where the chilled water stream is used in heat exchangers, such as a fan and heat exchange coil system, to produce cool air and pass the cool air into an area which is to be cooled.

Currently many such system are installed in areas where it is necessary to drill wells in the residential yard or the like to circulate water to cool the water by heat exchange with the ground to produce sufficiently cool water to cool the heated, compressed refrigerant. In many instances, either because of local climatic conditions or the continued circulation of water through the ground piping network, the recovered water becomes so warm that the water may be recovered at temperatures in excess of 100° F. This water is not suitable for use as a coolant for the hydronic coolers.

Accordingly an improved system has been desired which does not require a subterranean well system, which can produce cooled water at all air temperature conditions and which can supplement cooling available from a subterranean well system.

### SUMMARY OF THE INVENTION

The present invention comprises a system for cooling a refrigerant stream with an inlet air stream, the system comprising: an air permeable evaporative media; an air inlet positioned to pass an air stream through the evaporative media; at least one water spray positioned to spray finely-dispersed water droplets into the air stream in an evaporative cooling zone, upstream, relative to air flow, from the evaporative media; an air-to-water heat exchanger having a water inlet and a cooled water outlet and positioned downstream, relative to air flow, from the evaporative media; a fan positioned to cause the air stream to flow through the evaporative cooling zone, the evaporative media and the air-to-water heat exchanger; and, an enclosure enclosing a passageway for air flow through the evaporative cooling zone, the evaporative media and the air-to-water heat exchanger coil to produce a cooled water stream.

The invention further comprises a system for cooling a refrigerant stream with a cooled air stream, the system comprising: an air permeable evaporative expanded area media; an air inlet positioned to pass an air stream through the evaporative media; at least one water spray positioned to spray finely-dispersed water droplets into an evaporative cooling zone upstream, relative to air flow of the evaporative media; an air-to-refrigerant heat exchanger coil having a refrigerant inlet and a cooled refrigerant outlet and positioned downstream, relative to air flow, from the evaporative media; a fan positioned to cause the air stream to flow through the evaporative cooling zone, the evaporative media and the air-to-refrigerant heat exchanger; an enclosure enclosing a passageway for the air stream through the evaporative cooling zone, the evaporative media and the air-to-refrigerant heat exchanger coil.

The invention also comprises a system for cooling a refrigerant; the system comprising: an air permeable evaporative expanded area media having an upstream side and a downstream side relative to air flow through the evaporative media; an air inlet positioned to pass an air stream through the evaporative media; at least one water spray positioned to spray finely-dispersed water droplets into an evaporative cooling zone upstream, relative to air flow of the upstream side of the evaporative media; an air-to-water heat exchanger having a water inlet and a cooled water outlet and positioned downstream, relative to air flow, from the downstream side of the evaporative media; a fan positioned to cause the air stream to flow through the evaporative cooling zone, the evaporative media and the air-to-water heat exchanger; an enclosure enclosing a passageway for air flow through the evaporative cooling zone, the evaporative media and the air-to-water heat exchanger coil and, a refrigerant heat exchanger for cooling a compressed warm refrigerant and having a warm refrigerant inlet and a cooled refrigerant inlet and a cooling water inlet and a cooling water outlet so that the cooling water is in heat exchange with the refrigerant to cool the refrigerant and produce a cooled refrigerant.

The invention also comprises a system for cooling an area with a hydronic cooling system, the system comprising: an air permeable evaporative media; an air inlet positioned to pass an air stream through the evaporative media having an upstream side and a downstream side relative to air flow through the evaporative media; at least one water spray positioned to spray finely-dispersed water droplets into an evaporative cooling zone upstream, relative to air flow of an upstream side of the evaporative media; an air-to-water heat exchanger having a water inlet and a cooled water outlet and positioned downstream, relative to air flow, from the downstream side of the evaporative media; a fan positioned to cause the air stream to flow through the evaporative cooling zone, the evaporative media and the air-to-water heat exchanger; an enclosure enclosing a passageway for air flow through the evaporative cooling zone, the evaporative media and the air-to-water heat exchanger coil and, a hydronic cooler including a refrigerant heat exchanger for cooling a compressed warm refrigerant and having a warm refrigerant inlet and a cooled refrigerant outlet and a cooled water inlet and a warm water outlet so that cooling water can be passed in heat exchange communication with the refrigerant to cool the refrigerant and a refrigerant-to-water heat exchanger to produce cooled water for passage to a cooling coil for the area.

The invention further comprises a system for cooling ground water, the system comprising: an air permeable evaporative expanded are media having an upstream side and a downstream side relative to air flow through the evaporative media; an air inlet positioned to pass an air stream through the evaporative media; at least one water spray positioned to spray finely-dispersed water droplets into an evaporative cooling zone upstream, relative to air flow of an upstream side of the evaporative media; an air-to-water heat exchanger having a water inlet and a cooled water outlet and positioned downstream, relative to air flow, from the downstream side of the evaporative media; a fan positioned to cause the air stream to flow through the evaporative cooling zone, the evaporative media and the air-to-water heat exchanger; an enclosure enclosing a passageway for air flow through the evaporative cooling zone, the evaporative media and the air-to-water heat exchanger coil and, a line for passing at least a portion of a cooled water stream from the cooled water outlet into the at least one ground well to cool the subterranean zone penetrated by the at least one ground well; and, a line for recovering water from the at least one well penetrating the subterranean formation and passing the recovered water to the water inlet to the air-to-water heat exchanger.

The invention also comprises an apparatus for improving the efficiency of a heat exchanger having a fluid inlet line and a cooler fluid outlet line, the apparatus comprising a crossover line from the outlet line to the inlet line adapted to pass a portion of the cooled fluid in the fluid outlet line to the fluid inlet line.

The present invention includes a system for moving one or a plurality of nozzles through a pattern relative to the media.

The invention also includes a computer program including sensors for cooling system operation to optimize cooling system efficiency.

The cooling system may be used as an area cooling system by discharging the cooled air into the area.

The system may also include a heater to supply heated water to the system when desired.

### BRIEF DESCRIPTION OF THE DRAWINGS

FIG. 1 is a schematic diagram of an embodiment of the present invention wherein the exhaust air, after cooling the water stream, is discharged through a roof-mounted vent;

FIG. 2 is a schematic diagram of a further embodiment of the present invention;

FIG. 3 is a schematic diagram of the invention positioned in a dwelling having a ceiling and an attic;

FIG. 4 is a schematic diagram of the apparatus of the present invention in combination with a coiled tube system for use in hydronic cooling system in a closet or the like space;

FIG. 5 is chart showing the efficiency of an evaporative media at various wet bulb versus dry bulb ratios as a function of the face velocity through the media;

FIG. 6 shows the pressure drop at various velocities across media of various thicknesses;

FIG. 7 is a schematic diagram of a further embodiment of a spray apparatus for use with the present invention;

FIG. 8 is a schematic diagram of a further embodiment of the present invention;

FIG. 9 is a schematic diagram of an embodiment of a hydronic cooling system embodiment of the present invention;

FIG. 9A is a schematic diagram of a fan coil;

FIG. 9B is a schematic diagram of top view of nozzles in position relative to the media;

FIG. 9C is a schematic diagram of a nozzle mount and a pattern of nozzle mount movement;

FIG. 10 is a schematic diagram of an embodiment of an alternate embodiment of the present invention; and,

FIG. 11 is a schematic diagram of an alternate embodiment of the present invention;

FIG. 12 is a top view of a device for moving the nozzle mount through a selected pattern relative to the media;

FIG. 13 is a side view of the device shown in FIG. 12;

FIG. 14 is a schematic diagram of a further embodiment of the present invention; and

FIG. 15 is a flow sheet of the operation of a computer system for controlling a cooling system of the present invention.

### DESCRIPTION OF PREFERRED EMBODIMENTS

In the discussion of the Figures, not all fans, valves and the like necessary to achieve the flows described have been included for simplicity.

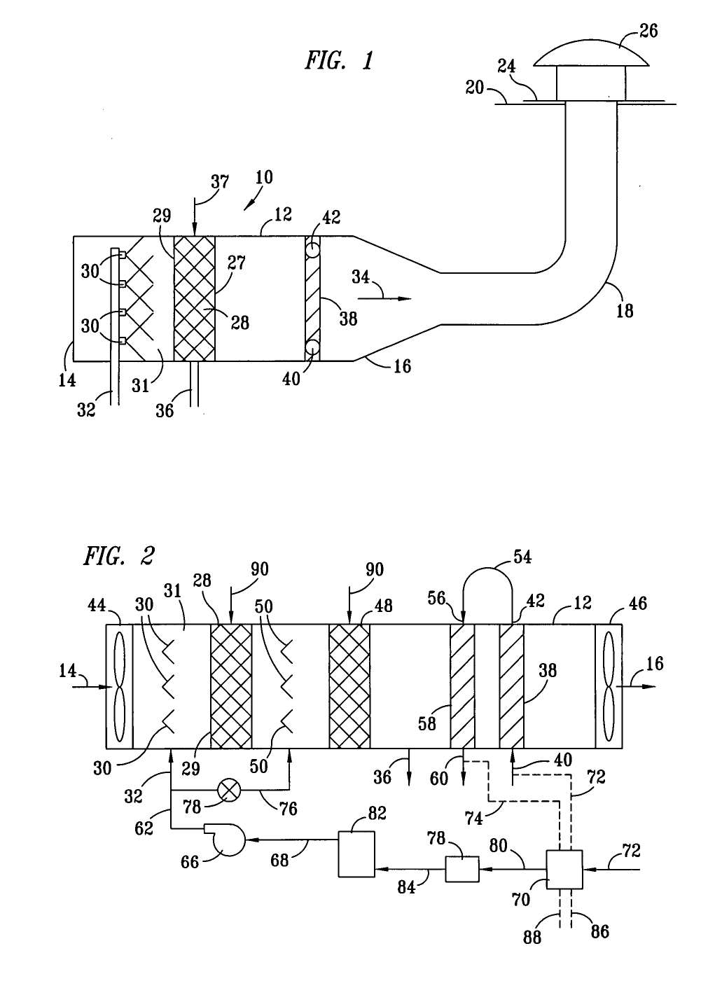

In FIG. 1 an embodiment 10 of the present invention is shown. An enclosure 12 is shown schematically and an air inlet 14 is shown for passing air into the enclosure with the air being discharged through an outlet 16 in a direction shown by an arrow 34. The enclosure contains an evaporative media. Such evaporative expanded area media materials are available in custom sizes and flute angles and are used for intimately contacting water and air for cooling an air stream. A pad of an evaporative media material, such as the material produced and sold for evaporative cooling systems by General Shelters, P.O. Box 2108, Center, Tex., 75935 under the trademark “KUUL PADS” is shown to be useful in the present invention and is used in the description of the present invention, although other functionally similar materials may be used. A pad of the expanded area material evaporative media is shown at 28 and as shown is positioned downstream from a plurality of water spray nozzles 30.

While a plurality of spray nozzles can be used, it is preferred that a one or two nozzle programmable spray system be used as discussed below. These nozzles are supplied with water through a line 32. These nozzles desirably disperse the water very finely into droplets of typically about 5 microns. The water is dispersed into an evaporative cooling zone 31 between the nozzles and an upstream side 29 of the evaporative media, the air stream moving, as shown, toward evaporative media 28. In the event that the water is not totally evaporated, a drain 36 is provided. The water recovered at the drain may be recycled to a water inlet 37 through which it is passed directly onto evaporative media 28. It is expected that 99% or more of the water injected will be evaporated.

The cooled air leaving a downstream face 27 of evaporative media 28 (downstream refers to the direction of air flow in the unit) is cooled and passes to an air-to-water heat exchanger coil 38. Suitable air-to-water heat exchanger coils are available from First Operations, L. P., P.O. Box 27969, Dallas, Tex. Desirably zone 31 is a distance of about 10 to about 26 inches between the nozzles and the upstream side of the evaporative media. Heat exchanger 58 includes a water inlet 56 and a cooled water outlet 60. This cooling system is capable of cooling the water to temperatures which are very acceptable for use in fan coil units, such as commercial water coils marketed as CWC Series by First Operations L. P., P.O. Box 27969, Dallas, Tex. 75227, for hydronic cooling.

While the air-to-water heat exchanger has been described as an air-to-water heat exchanger, the heat exchanger may also be an air-to-refrigerant heat exchanger. Air flow through the unit is shown by arrow 34. Discharged air, as shown, is passed via a line 18 through a roof 20 via a flange fitting 24 to a covered discharge fan 26.

The media disclosed has fluted passageways therethrough. The passageways are oriented at an angle of about 45° from the face of the media (although a wide range of angles is effective). In a preferred embodiment, at least two, and optionally more, thin sections of media are positioned across the air flow pathway so that the media passageways are oriented to cause the water droplets to change directions in the air flow passageway. The passageways may be oriented at about 30 to about 180° from each other but any angle suitable to change the direction of the water droplets is effective. The sections of media may be positioned next to each other, but desirably the thin sections are spaced apart. Spacings can vary widely but spacings from 0.1 to 2.0 inches or more are considered suitable.

Desirably the water droplets are sufficiently small so that a mist is formed. “Mist” is defined as a suspension of water particles in a gas wherein the water particles are so small that they remain in the gas for a substantial period. Typically the time is at least 0.5 hour.

In FIG. 1 four nozzles are shown. It has been found that fewer or more nozzles can be used. The nozzles are preferably positioned to inject water droplets into substantially the cross-sectional area of the air flow passageway. The nozzles may be positioned on a manifold or the like for movement during injection. Desirably the movement provides a sweeping injection zone for water droplets. Flat sprays oriented to sweep the cross-sectional air flow passageway are preferred. The sweeps may be either vertical or horizontal or the like. Any pattern which sweeps the cross-sectional area is suitable. These arrangements provide better coverage of the cross-sectional area, require fewer nozzles and require less water since better coverage of the cross-sectional area and the media and more efficient evaporation is achieved.

As shown in FIG. 2, two evaporative media sections 28 and 48 are included. While these sections are shown widely separated, it is preferred that they be closely spaced, i.e., at least about 0.1 inches. Two sets of spray nozzles 30 and 50 are included and two air-to-water heat exchangers 58 and 38 are included. The air is cooled as discussed previously and a drain 36 is shown for removing water as necessary from enclosure 12 for recycle, as previously discussed. The cooled air is passed through air-to-water heat exchanger (alternatively, air-to-refrigerant) coils 38 and 58 as shown. The inlet water is passed to heat exchanger 38 via a line 40 and then passed from an outlet 42 through an line 54 to an inlet 56 to heat exchanger 58 from which it is recovered as cooled water through a line 60. Air is caused to flow through the unit by either a fan 44 at the inlet or a fan 46 at the outlet. In other words, the air can either be pushed through or pulled through the unit. Both fans could be used if desired but it is expected that in most instances only one fan and one heat exchanger will be necessary

In FIG. 2, sensors 72 and 74 are shown sensing the temperature difference between lines 40 and 60 to measure the effectiveness of the cooling. This information is supplied to a solenoid 70 which controls the flow of inlet water through line 72 to the cooling system in FIG. 2. Sensors 86 and 88 (shown by dotted line connections) are provided for sensing the wet and dry bulb temperature of the air and providing this information to solenoid 70 through a control circuit, such as a programmable logic controller available from General Electric Company. Based upon this information, the unit is readily controlled to use greater or lesser volumes of air and water to produce the desired temperature difference between lines 40 and 60. The water flow from solenoid 70 passes through a line 80 to a water treatment cartridge 78, such as water treatment cartridges available from Ampac USA, which prevents the precipitation of water-soluble salts in the unit as evaporation occurs. The water treated by the cartridge is recovered through a line 84 and passed to a water filter 82 where the water is filtered and passed via a line 68 to a high pressure pump 66. The water is then pumped through a line 62 to line 32 and to nozzles 30 or through a line 76 and a valve 78 to nozzles 50. The water may be treated and filtered by a variety of means well-known to the art for removing particulates from the water. This allows close control of the unit to produce the desired temperature difference between the inlet air and the outlet air.

This unit is relatively compact and requires little power to produce the desired air cooling. With this cooled air stream, coil units can readily produce a chilled hydronic water stream which is suitable for use to cool an enclosed area, such as a dwelling, an industrial area which may contain temperature sensitive equipment such as computers and the like, swimming pool areas or the like. This eliminates the need for extensive and expensive outdoor drilling to produce a source of cooled ground water which may not in fact be cool in the summer in any event.

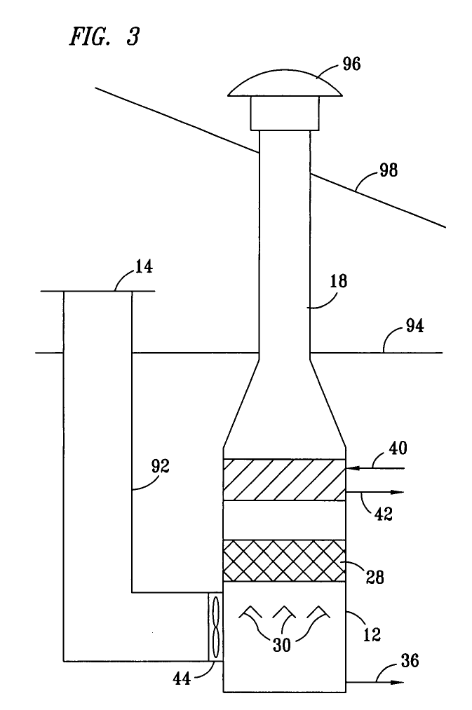

The unit can readily be placed in any convenient location in or on a dwelling and the air can be drawn from the outside through a suitable grate from an attic or an other available source and passed through the unit for cooling with the discharge stream being discharged into an area inside the dwelling, outside the building for instance, through the roof, through a vent in the wall or the like. The unit can be positioned readily and used in combination with relatively small areas in a dwelling. If desired a drip water inlet 90 may be positioned to drip water at a selected rate into the top of either or both media sections 28 and 48. One or more drain tubes 36 may be positioned to drain liquid water from enclosure 12. For instance, FIG. 3 shows a unit in an upright position. In this position the air is vented through a vent 96 in the roof after passing upwardly through a ceiling 94 and a roof 98. The air inlet 14 via a duct 92 is shown in an attic area of a dwelling above the ceiling. A single fan 44 is used to operate the unit. Other details such as the water treatment and the like have not been shown but are also relatively compact and can be used in a small area.

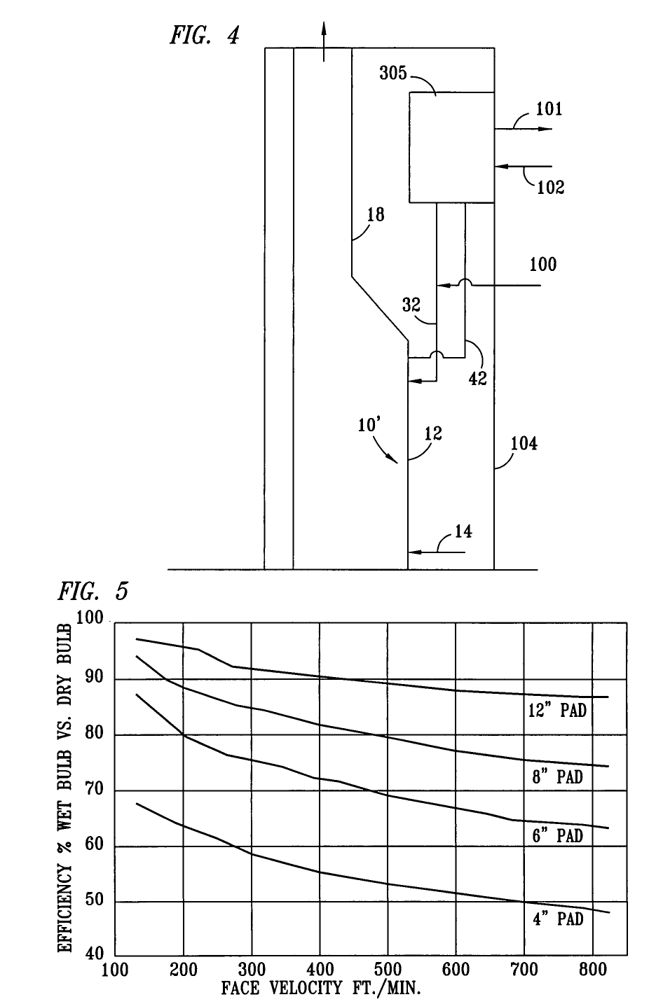

In FIG. 4, an embodiment 10′ of the cooling system is shown in a closet area with a hydronic cooler system 305 positioned above the cooling system. The hydronic cooling system receives a stream 102 of returned (warmed) cooling water from the areas cooled by the hydronic cooling system. This water is cooled, as discussed previously, in hydronic cooler system 305 and discharged as cooled water through a line 101 to a ductwork hydronic cooling system serving the area to be cooled. Cooled water from the cooling system is passed via a line 42 into unit 305 and may be recycled back to the cooling system as shown through a line 32 as inlet water to the cooling system with water being discharged or added via a line 100. As shown, the cooling system discharges air from the top of the unit and receives air from ground level. Many variations are possible in the arrangement of these units but in many instances these units can be installed in a very limited space inside a dwelling or the like for cooling. The water flows are readily controlled and the air is readily received and discharged harmlessly at a variety of points. The process emits no waste products other than water and near-water saturation air.

As indicated previously, the process of the present invention is readily used to operate residential and even outdoor applications where cooling is desired. As further discussed, it can be used in small closed spaces and requires minimal power. The water passed to hydronic cooling system 305 as inlet water may be return water from the hydronic cooling system or water produced from a well system. Use of the well system water as inlet water to the cooling system 10′ enables the cooling system to cool the inlet well water for return to the wells to cool the wells if not required for cooling in hydronic cooler 305.

The entire system, including the fan coil, typically will require approximately 5 kw of electric power for operation to cool and supply 3 tons of cooling. This is accomplished with no destruction to the ground surfaces and no expense for drilling expensive ground wells.

In FIG. 5, the efficiency of the cooling pads as a function of the percentage wet bulb versus dry bulb temperatures is shown. The relationship is shown as a function of the face velocity of the air through the evaporative media.

By the use of such information, with the use of pads of various thicknesses, those skilled in the art can readily determine the thickness of pad and the amount of water required to produce a desired amount of cooling.

In the present invention, the media may be single pads of various thicknesses, but desirably the pads are relatively thin, such as from about 1 to about 8 inches and are spaced from each other by a spacing from about 0.1 to about 2.0 inches. The pads are also desirably rotated from about 30 to about 180° relative to each other, and preferably about 90 to about 180°, so that the air flow through the pads undergoes a direction change from a first pad to a second or subsequent pad. The pads may be against each other and rotated, rotated and spaced-apart or spaced-apart. These arrangements are considered to provide improved evaporation of the water droplets which enter the evaporative media. The number of pads can be adjusted as necessary to evaporate substantially all (i.e., about 99%) of the water droplets entering the media from the evaporative cooling zone.

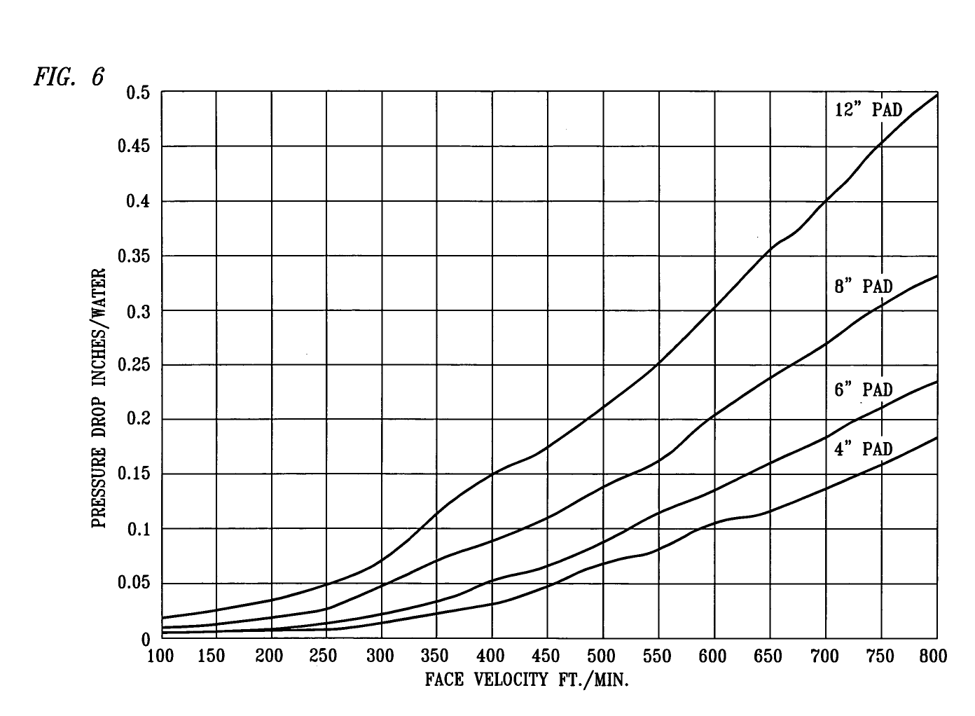

In FIG. 6 a pressure drop in inches of water across pads of various thicknesses is shown in relation to the face velocity in feet per minute.

The pads may become partially blocked or the like with dissolved salts and the like from the evaporated water. In this event, air velocity may be reduced. If so, the pads may be replaced since they are relatively inexpensive. It is expected that any such blockage will be infrequent (i.e., 2-3 years) in view of the water treatment prior to evaporation.

Cooling is achieved by the use of nozzles which deliver a spray of water particles typically from about 5 microns to about 15 microns in average diameter. These nozzles may be positioned as shown in FIG. 1 or in any other suitable arrangement for spraying water into the evaporative cooling zone. For instance, the nozzles may spray toward or away from the media into the air stream. Suitable nozzles are available for varied spray volumes at various pressures from Arizona Mist, Inc., 1051 North Fiesta Blvd., Gilbert, Ariz. 85233. The finely dispersed spray from 0.020 inch diameter nozzles at spray nozzle pressures of about 800 to about 1000 psi or higher, immediately flashes as sprayed to evaporate a high percentage of the water, typically greater than about 90 and preferably greater than about 95 weight percent of the water. This evaporation causes a major cooling of the air stream so that a smaller cross-section of a thinner media may be used.

The dispersion of water may be variously characterized as a fog or a mist, which is generally considered to be from about 5 to about 10 micron average diameter water droplets which float in the air. Finely dispersed sprays are generally comprised of about 10 to about 50 micron diameter particles which appear to be a mist as dispersed. A high degree of evaporation is achieved with this dispersion of materials.

Dispersions, which are substantially fog, are produced with a very high pump pressure, i.e., from about 800 to about 1000 psig and higher, and with relatively small diameter nozzles, i.e., 0.008 to about 0.018 inch diameter nozzles. These dispersions typically evaporate to a high degree, i.e., up to about 25 percent, within the evaporative cooling zone so that a major amount of the water evaporates in the media. This results in surprisingly efficient cooling and in from about 95 to about 100 percent water evaporation. The cooling with the spray nozzles dispersing fine water droplets into the air, plus the cooling achieved by the evaporation within the media in its normal operations using a drip onto the top of the media is less than achieved by the sprays and the media in combination, according to the present invention. Accordingly, the cooling system of the present invention shows a synergistic improvement in cooling as a result of the combination of the nozzles and the media. Desirably the media surfaces are wet by water droplets carried onto the media so that the media presents a wet surface to the air flow so that greater evaporation is achieved than with the use of a drip which only partially wets the surfaces of the media.

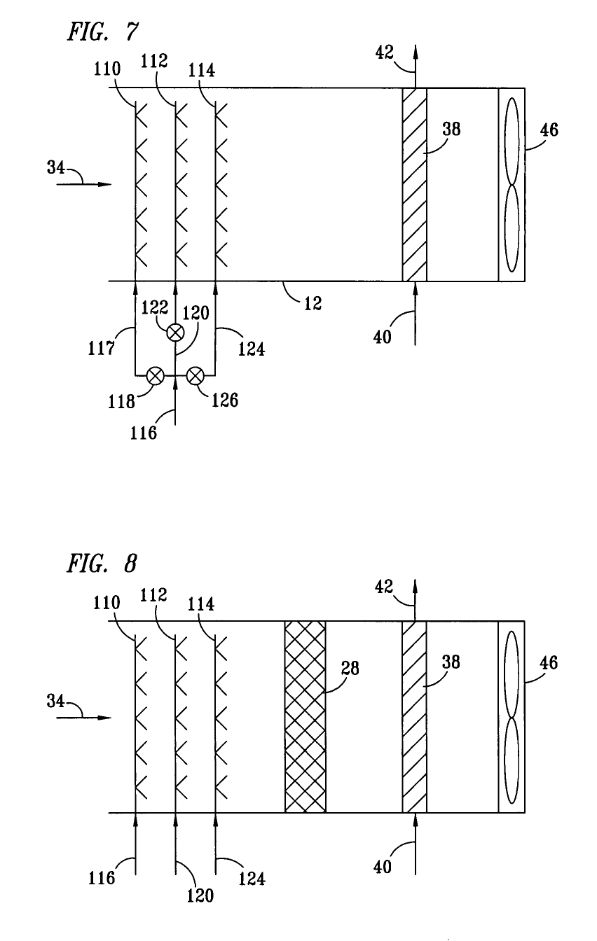

A nozzle arrangement is shown in FIG. 7 wherein three banks of nozzles, 110, 112 and 114, are positioned to spray at high pressure as discussed above to cool an air stream flowing past the nozzles as discussed above. The amount of water added can be varied by selecting one or more banks of nozzles. The nozzles are desirably of different spray capacities and can be selected for use alone or in any combination. It should be understood that in some embodiments a single nozzle may be sufficient.

This control is achieved by feeding water at variable rates and optionally variable pressures via separate feed lines to each bank of nozzles. It will be understood that one, two, three or more banks of nozzles could be positioned to inject water spray from a single water source or the like. As shown, a line 116 supplies water to lines 116 containing a valve 118, a line 120 containing a valve 122 and a line 124 containing a valve 126 supply water to nozzles 112 and 114 respectively. This arrangement provides separate water feed streams to the banks of nozzles 110, 112 and 114.

The water is desirably treated by filtration to remove particulates which are of a size sufficient to plug the nozzles. Filters for this purpose are well-known to those skilled in the art. Suitable filters are available from Ampac USA. Further the water should be treated to remove ions from the water so that evaporation of the water in the unit does not create a problem from deposits from the water over time.

The banks of nozzles can be used alone as described above or can be used with a relatively thin section of media as shown in FIG. 8. The media tends to even the flow through the enclosure and provides more efficient cooling in the unit.

In either event the nozzles may be arranged in any suitable pattern to achieve optimum results.

The amount of water to be evaporated from the sprays and on the media is readily calculated based upon the wet and dry bulb temperatures of the air stream, the evaporative efficiency of the unit and the desired amount of cooling to be achieved with the water stream cooled in the air-to-water heat exchanger.

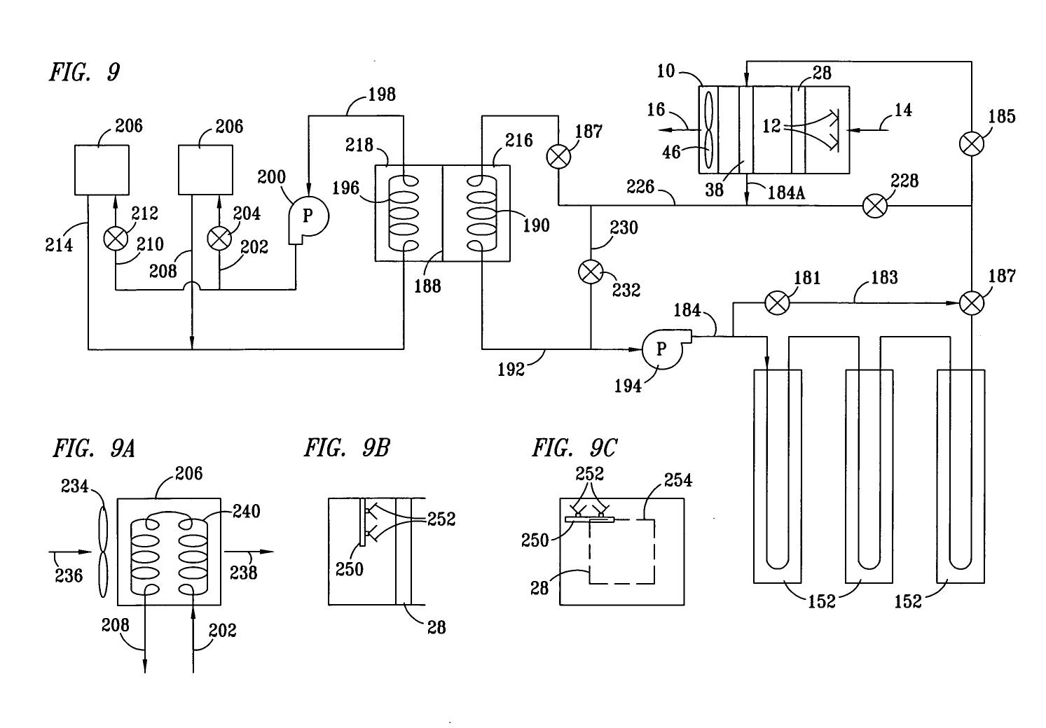

In FIG. 9, a schematic diagram of an embodiment of a hydronic cooling system of the present invention is shown wherein water is cooled in a plurality of wells 152 as shown by a flow through a heat exchange system in wells 152 via a line 184. Line 184 produces a cooled stream of water from the wells with the cooled water being passed either to a water source heat pump 188 or the like or to cooling in a cooling system 10, according to the present invention. When the water is passed to cooling system 10, the flow is directed through a valve 185 and a valve 187 with a valve 288 in a line 226 being closed. This cooling system is as shown schematically and includes nozzles 12 and air inlet 14 and air outlet 16, a fan 46, a cooling media 28 and an air/water heat exchange 38. The cooling system has been described previously as have the wells. The water flowing through cooling system 10 is recovered via a line 184A and passed to line 226 through a valve 187 and to a water source heat pump 188 with valve 232 in line 230 being closed. The cool water passes through a water/refrigerant heat exchange coil 190 in a compressed refrigerant cooling said 216 of the water source heat pump. The water is then passed through a line 192 and a pump 194 to line 184 and recycled back through the wells. The cooled refrigerant from coil 190 is then passed to a water/refrigerant heat exchange coil 196 where the refrigerant is expanded to cool a water stream from a line 214 with the water stream being passed through water/refrigerant heat exchange coil 196 to a line 198 to pump 200 and line 202, including a valve 204 to a fan coil 206 to cool an area of a room or the like. The water, after heat exchange in fan coil 206, is recovered via a line 208 and passed via lines 208 and 214 back to coil 196. A second fan coil 206 is shown with a second stream of the cooled water passed via a line 210 and a valve 212 to the second fan coil. In the second fan coil, the cool water is heat exchanged with air to cool a second area with the warmed water then being recovered via a line 214 and passed back to coil 196.

It will be understood that the refrigerant in the fan coils, if desired, could be the cooled refrigerant which expands in the fan coil to produce the cooling desired in the selected area. In such an instance, the coil 196 would be replaced by a plurality of small coils in the fan coils 206 in selected areas so that the refrigerant is allowed to vaporize in the fan coils for subsequent return to the water source heat pump for recompression and cooling.

In the event that the cooling is not necessary or desired in the selected area, then the cooled water from system 10 can be routed via lines 184A, 226 and 230 to line 192 for circulation through wells 152. This permits the use of the cooling system to cool the wells so that when greater cooling is desired the water can be recovered from the wells at a lower temperature.

In a further variation, if it is desired to supply cooling solely with cooling system 10, the water returned from water source heat pump 188 can be passed through line 192, pump 194 and line 184 to a line 183, including a valve 181 to line 184. When no flow is desired through line 183, valve 181 may be closed and valve 187 may be closed, thus isolating the water flow through wells 152 so that system 10 is the sole cooling system for use with the water source heat pump.

As clearly shown above, there are many variations which could be used. For instance, each well could deliver a stream of water cooled in the well to a return line rather than being connected in series as shown and the like. The present invention includes the use of the cooling system described in detail previously in conjunction with a hydronic water or refrigerant cooling system.

In FIG. 9A, a fan coil 206 is shown. A cooling water stream or a refrigerant stream is passed via a line 202 into a coil 204 where the cool water is heated by an air stream blowing through the coil heat exchanger as shown by arrows 236 which shows inlet air moved by a fan 234 through fan coil 206 to produce cooled air through line 238. The warmed water is then recovered through a line 208 and returned back to the dual source heat pump. Similarly refrigerant may be passed directly from the dual source heat pump to the fan coil and vaporized to cool an air stream as discussed for the air flow.

FIG. 9B is a schematic diagram of a top view of a spray nozzle support 250, including a pair of nozzles 252. One or more nozzles may be used on the nozzle support which is moveable relative to the media 28.

In FIG. 9C, a pattern 254 is shown for movement of nozzle support 250 which is desirably moveable in either a horizontal and a vertical direction or both and may be moved by use of stepper motors and engageable belts, or the like, which are effective to move the nozzle support horizontally with a second system being provided for moving the nozzle support vertically. Desirably the stepper motors are responsive to a computer program capable of directing movement of the nozzle support in a selected pattern, such as pattern 254, in response to variables such as the outlet water temperature from system 10, the relative air humidity, the amount of cool water required and the like to select a proper pattern for movement and a proper movement rate to introduce a proper amount of water into system 10 to produce the desired amount of cooling. Such variations are well within the skill of the art and need not be discussed in greater detail.

Based upon the previous discussion of FIG. 9, it will be noted that the cooling system can readily be added to existing systems where the wells do not provide sufficient cooling and that system 10 can also be used as a stand alone system for providing cooling to a water source heat pump. Many variations in the flow diagrams are possible with the use of system 10 to achieve these goals.

As indicated previously, when no cooling is required, the air cooling system of the present invention may be used to simply cool the ground area in the vicinity of wells 152 so that lower temperatures can be achieved in the water return from these wells when cooling is required. Such variations are well within the skill of those in the art and need not be discussed further. Details of the use of the cooling system of the present invention have been previously discussed.

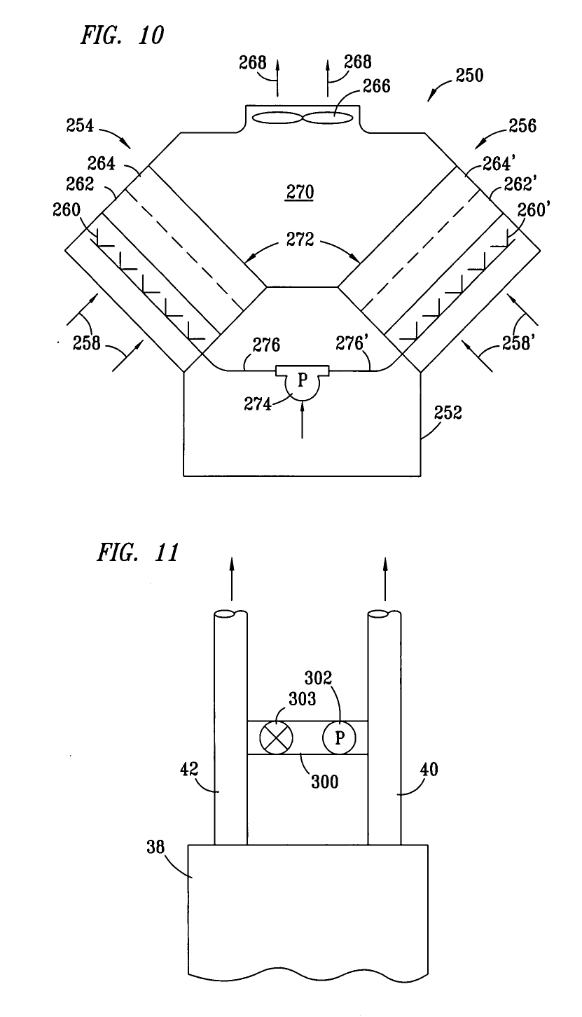

In FIG. 10 an alternate embodiment of the present invention is shown. In this embodiment, a two-cell cooling system 250 is shown. The two cells 254 and 256 are supported on a stand 252 and comprise first cell 254 and second cell 256. Water flow is provided by a pump 274 through lines 276 and 276′ to the two systems. Air flow is supplied to the systems via lines 258 and 258′ with the sprays being shown at 260 and 260′. The media is shown at 262 and 262′. The systems include air-to-water heat exchangers 264 and 264′ and operate as discussed above. The exhaust air is recovered at 268 with the cooled air being recovered from air-to-water heat exchanger 264 and 264′ as discussed above in connection with the air-to-water heat exchanger. Exhaust fan 266 is used to discharge air through exhaust 268. An air collection zone 270 is shown. The two cells are positioned at an angle to 272 which may vary from about 90 to about 120°. By this embodiment, two cooling cells are positioned in close proximity for operation with an economy of equipment. In other words, only a single water pump is required and only a single exhaust fan is required. It will be clear to those skilled in the art that an additional two cells can be positioned orthogonally to the two cells shown to provide a four cell system. Such variations are well in the skill of those within the art. The cooling cells shown basically comprise the use of sprays, an evaporative cooling section, media and air-to-water heat exchangers as discussed in greater detail above.

In FIG. 11 a further embodiment is shown. In this embodiment lower temperatures can be archived in the air-to-water heat exchanger. A water inlet 40 is shown to an air-to-water heat exchanger 38. Similarly an outlet 42 is shown for the cooled water exiting air-to-water heat exchanger 38. By the improvement shown in FIG. 11, a crossover line 300 is provided and includes a valve 303 and a pump 302. In the practice of the invention shown in FIG. 11, a portion of the cooled water is passed through crossover 300 to line 40 to form a portion of the inlet water. For instance, when 50% of the cooled water is routed through line 300, a cooler outlet stream is recovered through line 42. When an inlet stream having a temperature of 85° F. is charged to unit 38, with the outlet stream recovered being at a temperature of 78° F., then if one-half of the outlet stream is passed through line 360, the new outlet stream can be at a temperature of about 74° F. Only half as much water is cooled in this way, but a greater temperature reduction is readily achieved.

In the practice of the present invention, the pumps for the water supply to the nozzles, the supply of water to the air-to-water heat exchanger and the fans may be powered by any suitable means. For instance, electrical motors and pumps may be used, hydraulic pumps and motors may be used and the like. Particularly, for the water supply to the sprays, it is preferred that electric pumps be used. These pumps are relatively small.

For the larger pumps required to pass the water to the air-to-water heat exchanger and for power to drive the fan motors, it is preferred that hydraulic power be used. Hydraulic power for the fans and a high pressure water pump for the water passed to the air-to-water heat exchanger may be placed in a General Electric Company hydraulic pump station with directional control valving, proportional control valving and a programmable logic controller with a temperature sensor connection to economize the operation of the cooling unit by varying the fan speed proportional to the cooling air temperature and the condenser water temperature. This reduces the basic cooling cell to a water cooling coil media, single or double hydraulic fan motor assemblies, a spray nozzle manifold and temperature sensors in an enclosure with no electric power to the enclosure. The separate central power unit would concentrate all hydraulic power in one hydraulic pump for the fans and high pressure water pump to power multiple cooling cells.

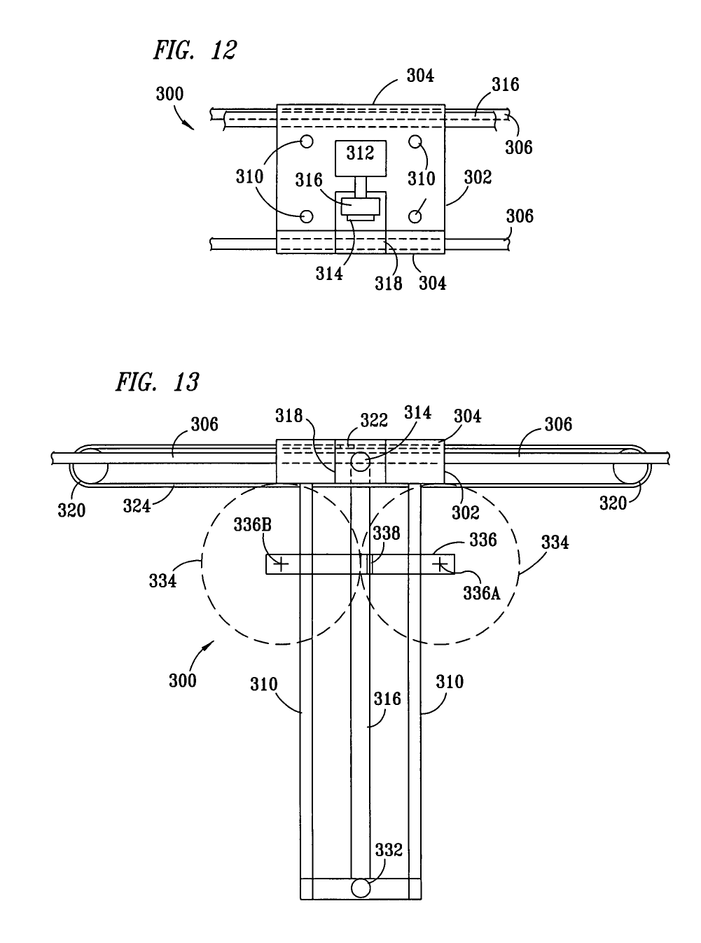

As previously discussed, it is desirable that the nozzles be programmably moveable through a selected pattern to spray water toward and onto the media or that they may be mounted for movement whether or not programmable, as shown in FIG. 12 and FIG. 13, to spray water onto the media in a controlled pattern. In FIG. 12, a top view of an apparatus for achieving these objectives is shown. The apparatus comprises a block 302 of an apparatus 300. A recessed area 304 is provided on the top of block 302 to permit movement of a gear belt 316 or the like. This belt is a belt, such as a timing belt, v-belt, chain drive, cable drive, flat belt, or the like, which could have gears formed in one of its sides. The block is flexibly supported on supports 306, which as shown are rods but could be rollers in a tray or the like. The block supports rods 310 which may or may not extend to the top of block 302. These rods extend toward the lower portion of the passageway in front of the media. A stepping motor, DC motor, SERVO or variable voltage motor, or the like 312, is positioned in operative contact with block 302 to drive a gear 314 which is engaged by a second timing belt or drive 316. The second timing belt or drive, as will be discussed further, activates the vertical movement of a nozzle manifold 336 which as shown includes two nozzles, 336A and 336B. These nozzles generate spray patterns 334, as shown, and are directed toward media 28.

In the operation of the nozzle mounting apparatus, gear or drive pulley 314 engages belt 316 and moves belt 316 which is attached to the nozzle manifold at a fastener 338 to cause the manifold to move upward and downward along rods 310 which desirably are positioned through nozzle manifold 336. The nozzle manifold may engage two of rods 310 or all four of rods 310 as desired. As the nozzle manifold moves downwardly as a result of the movement of belt 316, belt 316 moves around an idler pulley 332 positioned near the bottom of rods 310. This permits movement of the nozzle manifold up and down in the air passageway of the cooling system 10. A second belt 316 is driven by a gear or drive pulley 326 which is driven by a motor (not shown) to rotate, as shown, in a recess section 304 of block 302 and around the bottom of block 302. This belt also engages an idler pulley 328 at the opposite side of the air passageway through the cooling system. As it rotates, block 302, which is connected by a fastener 322 to belt 316, moves block 302, including the rods and other apparatus suspended from block 302 horizontally across the passageway. By use of this device, the nozzle manifold can be caused to move through a pattern such as shown in FIG. 9C. Various other patterns can be used also and desirably the stepper motors are controlled by a computer program designed to provide a controlled, patterned spray onto media 28.

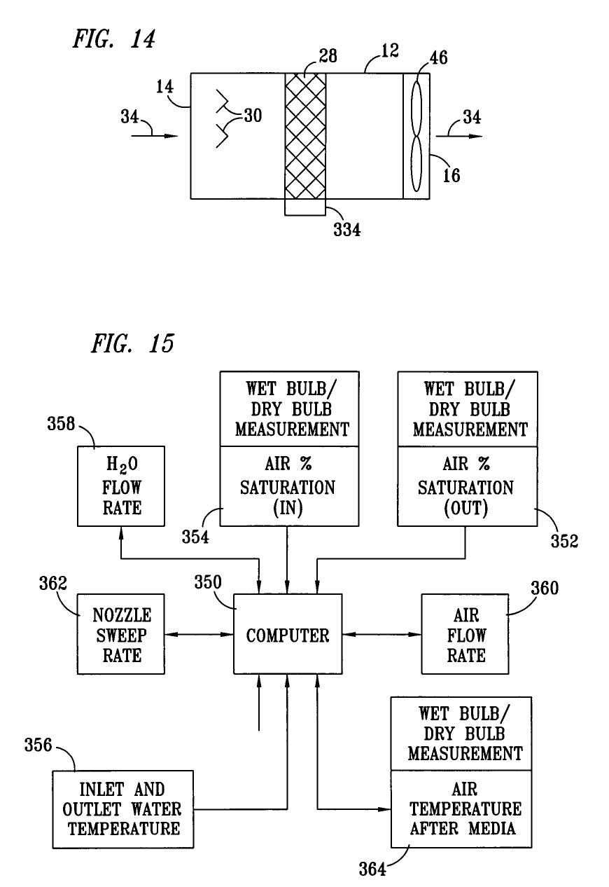

In a further embodiment of the invention, the cooling system may be used simply to cool a room. Such am embodiment is shown in FIG. 14 and does not include a heat exchanger system for air to water heat exchange. In other words, water is sprayed onto media 28 in a suitable quantity, either with or without a programmed pattern generation, and provides cooling for air which is discharged as shown via arrows 34. Nozzles 30 are shown 10 to supply water near a first end 14 of the cooling system with the water being partially evaporated before it contacts media 28 where the bulk of the water is evaporated with the water then being passed, as shown by arrow 34, out through a second end of the cooling system. Fan 46 is shown as a single fan but could be multiple fans and the like. Desirable the cooling system embodiments shown may be mounted on a mount 34 which permits it to be swiveled to either manually or controllably spray past cool air into an area. In this embodiment the amount of water inject may be somewhat reduced to reduce the humidity in the cooled air.

In FIG. 15, a flow chart of a computer implementing a program according to the present invention is shown. Information is supplied to the computer with respect to the inlet water temperature, at the percent water saturation (wet bulb/dry bulb temperature) of the incoming air at a step 354 with the percentage water saturation (wet bulb/dry bulb temperature) in the discharged air being measured as shown in 352. The computer program may be calibrated to produce 100 percent or as near 100 percent as is practical, saturated air.

The water flow rate into the cooling system is measured at 358 but may be at constant volume if desired. The volume may be regulated by the computer as necessary to produce the desired air saturation. Similarly the nozzle sweep rate may be varied and the sweep rate as monitored at station 362 may be input to and regulated by the computer to achieve the desired saturation. In the event an air-to-water heat exchanger is used, the inlet and the cooled water outlet temperature may be measured as shown at 356 with this information being supplied through the computer. The cool water outlet temperature is of considerable interest when the cooling system is used to cool refrigerant or other materials. The air flow is measured, as shown at 360, and is not only input to the computer but may be regulated by the computer. Similarly the air temperature downstream of the media may be measured prior to the contact with the air-to-water heat exchanger. In addition, while it is not shown, the computer may also drive an electronic camera which may be installed inside the air passageway at various places to determine the performance of the unit with its' display shown on an LCD included with a control thermostat, or the like.

The computer program may be implemented on any suitable personal or dedicated computer unit and is designed to calculate the water saturation in and out and control the cooling unit by making adjustments, as shown, to produce the desired water saturation in the air discharged from the cooling system.

The use of hydraulic power to power motors and pumps is well known and need not be discussed in detail except to point out that hydraulic power is readily usable to power a plurality of fan motors not only for a single unit but for possible multiple units if a larger installation is desired and can do so more readily, with more precise control and more economically than electricity. Electrical motors require more expensive controlling mechanisms and are less preferred to drive the fan motors and the heavier pump to move the water through the air-to-water heat exchanger. As stated previously, it is preferred to use electrical power for the very small pump used to supply water to the spray nozzles.

### EXAMPLE

An enclosure 24″×48″×72″ was constructed and an 8″ media material, as described above, was positioned in the structure to close the air passageway through the center of the structure. Water sprays having a nozzle diameter of 0.012″ were used at a pressure of 125 psi. A pump supplied by Granger Company, having a capacity of 0.3 gallon per minute, was used to pump water through the spray nozzles at a rate of 0.11 gallon per minute. This was observed to be an excessive amount of water and water drained from the enclosure. The inlet water was filtered and passed through a calcium inhibitor available from Ampac USA. At the time of the test, the ambient inlet air was at a dry bulb temperature of 93° F. with a wet bulb temperature of 83° F. The air passed through the unit was recovered at a dry bulb temperature of 70.2° F. The wet bulb temperature was depressed to 68.5° F.

This clearly shows that the cooling system of the present invention is very effective in cooling the air since cooling to the wet bulb temperature is the absolute that can be achieved. The approach to wet bulb was 17° F. using a water consumption of less than 0.1 gallon per minute.

As described above, the present invention is useful to cool air or it can be used alternatively by passing refrigerant through the air-to-water heat exchanger, which in this case would be an air-to-refrigerant heat exchanger to cool refrigerant for the hydronic cooling unit rather than using water to cool the compressed refrigerant commonly used refrigerants, such as fluorinated hydrocarbons, may be used. In other variations, the water can be used to cool the compressed refrigerant and can also be used as disclosed above to cool the wells used to cool water from the hydronic cooling unit. The invention of the present application is effectively to achieve these purposes.

While not shown in the figures, the hydronic system may also provide heating. The heating may be achieved by use of a water heating system, such as a conventional hot water heater, to produce heated water for circulation through the hydronic system to heat a selected space. The compression system may be used to supply heat by use of a hydronic water system stream to recover heat from a compressed halogenated hydrocarbon or the like refrigerant with the refrigerant then being vaporized by ground water.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

1. A system for cooling a water stream with an inlet air stream, the system comprising:
a) an air permeable, expanded area, evaporative media having an upstream side and a downstream side relative to air flow through the evaporative media;
b) an air inlet positioned to pass an air stream through the evaporative media;
c) at least one water spray positioned to spray finely-dispersed water droplets into an evaporative cooling zone upstream, relative to air flow, of an upstream side of the evaporative media;
d) an air-to-water heat exchanger having a water inlet and a cooled water outlet and positioned downstream, relative to air flow, from the evaporative media;
e) a fan positioned to cause the air stream to flow through the evaporative cooling zone, the evaporative media and the air-to-water heat exchanger; and,
f) an enclosure enclosing a passageway for air flow through the evaporative cooling zone, the evaporative media and the air-to-water heat exchanger coil.

2. The system of claim 1 wherein the fan is positioned in fluid communication with at least one of an inlet to the enclosure and an outlet from the enclosure and urges air through the enclosure.

3. The system of claim 1 wherein the at least one water spray nozzle is positioned to spray finely dispersed water droplets into the evaporative cooling zone and onto the evaporative cooling media.

4. The system of claim 1 wherein a programmably mobile single or multiple water spray nozzle system is used to spray finely dispersed water droplets into the evaporative cooling zone.

5. The system of claim 1 wherein the water spray nozzles spray finely-divided droplets having an average diameter of from about 5 to about 15 microns into the evaporative cooling zone.

6. The system of claim 1 wherein the evaporative media comprises a plurality of sheets of the evaporative media positioned across the passageway with the sheets of media being rotated by from about 30 to about 180° relative to each other.

7. A system for cooling a refrigerant stream with a cooled air stream, the system comprising:
a) an air permeable, expanded area, evaporative media having an upstream side and a downstream side relative to air flow through the evaporative media;
b) an air inlet positioned to pass an air stream through the evaporative media having an upstream side and a downstream side;
c) at least one water spray nozzle positioned to spray finely-dispersed water droplets into an evaporative cooling zone upstream, relative to air flow, of an upstream side of the evaporative media;
d) an air-to-refrigerant heat exchanger having a warm refrigerant inlet and a cooled refrigerant outlet and positioned downstream, relative to air flow, from the evaporative media;
e) a fan positioned to cause the air stream to flow through the evaporative cooling zone, the evaporative media and the air-to-refrigerant heat exchanger; and,
f) an enclosure enclosing a passageway for air flow through the evaporative cooling zone, the evaporative media and the air-to-refrigerant heat exchanger coil; and,
g) recovering a cooled refrigerant stream through the cooled refrigerant outlet.

8. The system of claim 7 wherein the refrigerant is a halogenated hydrocarbon refrigerant.

9. The system of claim 1 wherein the at least one water spray nozzle is positioned to spray finely dispersed water droplets into the evaporative cooling zone.

10. The system of claim 7 wherein the water spray nozzles spray finely-divided droplets having an average diameter of from about 5 to about 15 microns into the evaporative cooling zone.

11. A system for cooling a refrigerant, the system comprising:
a) an air permeable, expanded area, evaporative media having an upstream side and a downstream side relative to air flow through the evaporative media;
b) an air inlet positioned to pass an air stream through the evaporative media;
c) at least one water spray positioned to spray finely-dispersed water droplets into an evaporative cooling zone upstream, relative to air flow of the upstream side of the evaporative media;
d) an air-to-water heat exchanger having a water inlet and a cooled water outlet and positioned downstream, relative to air flow, from the downstream side of the evaporative media;
e) a fan positioned to cause the air stream to flow through the evaporative cooling zone, the evaporative media and the air-to-water heat exchanger;
f) an enclosure enclosing a passageway for air flow through the evaporative cooling zone, the evaporative media and the air-to-water heat exchanger coil and,
g) a hydronic cooler including a refrigerant heat exchanger for cooling a compressed warm refrigerant and having a warm refrigerant inlet a cooled refrigerant outlet, a cool water inlet, and a warmed water outlet so that the cooling water can be passed in heat exchange with the compressed warm refrigerant to cool the compressed warm refrigerant.

12. A system for cooling an area with a hydronic cooling system, the system comprising:
a) an air permeable evaporative media;
b) an air inlet positioned to pass an air stream through the evaporative media having an upstream side and a downstream side relative to air flow through the evaporative media;
c) at least one water spray nozzle positioned to spray finely-dispersed water droplets into an evaporative cooling zone upstream, relative to air flow of an upstream side of the evaporative media;
d) an air-to-water heat exchanger having a water inlet and a cooled water outlet and positioned downstream, relative to air flow, from the downside of the evaporative media;
e) a fan positioned to cause the air stream to flow through the evaporative cooling zone, the evaporative media and the air-to-water heat exchanger;
f) an enclosure enclosing a passageway for air flow through the evaporative cooling zone, the evaporative media and the air-to-water heat exchanger coil; and,
g) a hydronic cooler including a refrigerant heat exchanger for cooling a compressed warm refrigerant and having a warm refrigerant inlet and a cooled refrigerant outlet and a hydronic cooler cooling water inlet and a hydronic coil cooling water outlet so that the cooling water can be passed in heat exchange communication with the refrigerant to cool the refrigerant.

13. The system of claim 12 wherein the hydronic cooler includes an expander for expanding the cooled refrigerant to produce a cold refrigerant and a heat exchanger for passing the cold refrigerant in heat exchange with a water stream to produce a chilled water stream; and, a plurality of lines for passing the chilled water to a plurality of heat exchangers in the area to produce cooler air in the selected area to cool the selected area.

14. The system of claim 1 wherein the at least a portion of the cooled water stream from the cooled water outlet is injected into the at least one ground well to cool the subterranean zone penetrated by the at least one ground well.

15. The system of claim 14 wherein the plurality of systems are positioned to discharge cooled air into a common discharge zone.

16. An apparatus for cooling water to a temperature lower than the temperature reached by a single passage of a stream of water through an air-to-water heat exchanger, the apparatus comprising:
a) a water inlet line in fluid communication with a water inlet into the air-to-water heat exchanger;
b) a cooled water outlet line in fluid communication with a cooled water outlet from the air-to-water heat exchanger; and,
c) a crossover line in fluid communication with the cooled water outlet line and the water inlet line, the crossover including a valve adapted to pass a selected quantity of the cooled water from the cooled water outlet line to the water inlet line through the crossover line.

17. The apparatus of claim 16 wherein the crossover line includes a pump adapted to pump water from the cooled water outlet line to the water inlet line.

18. A system for moving at least one spray nozzle through a selected spray pattern directed toward an upstream side of an air permeable, expanded area, evaporative media positioned across an airflow passageway, the system comprising:
a) a nozzle manifold mounting;
b) at least one spray nozzle supported by the nozzle manifold;
c) a support adapted to move the nozzle manifold vertically in the passageway and supported from an upper side of the passageway; and,
d) a vertical drive system operatively engaging and adapted to move the support system horizontally in the passageway so that the nozzle manifold is moveable through a selected spray pattern.

19. The system of claim 18 wherein the nozzle manifold mounts at least two nozzles are supported by the nozzle manifold.

20. A computer program for controlling a system for moving a nozzle manifold through a selected spray pattern upstream directed toward an upstream side of an air permeable expanded area evaporative media positioned across an airflow passageway, the program comprising:
a) a determining an inlet water temperature and a percent water saturation of an inlet air stream;
b) determining the temperature and a percent water saturation of an outlet air stream downstream from the evaporative media;
c) determining an inlet water flow rate; and,
d) controlling at least one the inlet water flow rate, the outlet air temperature, the outlet air percent water saturation and the air flow rate to produce an outlet air temperature at a selected level.
